(19) United States
(12) Patent Application Publication
(10) Pub. No.: US 2019/0090552 A1
(43) Pub. Date: Mar. 28, 2019

(54) NEXT GENERATION UNDERWEAR FOR MEN AND WOMEN

(71) Applicant: Jordan Blake Crump, Tulsa, OK (US)

(72) Inventor: Jordan Blake Crump, Tulsa, OK (US)

(21) Appl. No.: 15/957,684

(22) Filed: Apr. 19, 2018

Related U.S. Application Data
(63) Continuation of application No. 15/900,780, filed on Feb. 20, 2018.
Application No. 15/900,780 is a continuation of application No. 15/831,095, filed on Dec. 4, 2017, now abandoned.
Application No. 15/831,095 is a continuation of application No. 15/713,677, filed on Sep. 24, 2017, now abandoned.

(51) Int. Cl. A41B 9/02; A41D 13/05; A41B 9/00; A61H 19/00; A61H 7/00

(52) U.S. Cl. CPC A41B 9/023; A41B 2400/32; A41B 2500/30; A41D 13/0525; A41B 9/026; A41B 9/004; A41B 9/001; A61H 19/32; A61H 2201/1692; A61H 2201/165; A61H 7/002; A61H 2201/1645

(57) ABSTRACT

A method and underwear system to better mitigate the genital chafing discomfort in men, as well as providing an improved means of absorbency for vaginal discharge in women.

The present application claims a priority date of Sep. 24, 2017.

The present application being a continuation of application Ser. No. 15/900,780 filed on Feb. 20, 2018, which in turn is a continuation of application Ser. No. 15/831,095 filed on Dec. 4, 2017, which in turn is a continuation of application Ser. No. 15/713,677 filed on Sep. 24, 2017.

### TECHNICAL FIELD

The present system is related to undergarments and more specifically to methods and systems for improved genital comfort.

### BACKGROUND OF THE PRESENT SYSTEM

Men and women both face unique problems in the area of functional genital comfort and each having their respective needs. The present system aims to resolve these problems once and for all.

The present system for males enables men to minimize the destructive and uncomfortable friction enacted upon the exposed erogenous portions of the penis.

In addition to resolving the issue of male chafing discomfort, sticking genitalia and restoring some loss of feeling to the erogenous zones of the penis, the present system provides users with a plethora of other benefits users can enjoy and experience whether circumcised or not. Some naturally circumcised men (born with shorter than normal foreskin) and intact men may take advantage of any or all the described benefits as well. Said benefits being overall improved genital comfort.

The present system for females enables the user to prevent noticeable vaginal discharge. Currently, it is typical for women to insert pads into the interior front face of their undergarments as a mitigative measure. The problems the present systems aims to address is the proper securement of said pads and to enable further protection of the undergarment from permanent soiling due to improper securement of said pads.

### Definitions

The term “outer shell” is to mean the fabric body to which the pouch structure is integrated.

The term “micro-suede” is to mean a fine napped fabric and is associated with the following terms in product information and/or advertising, to include but not limited to: 1. Ultrasuede, 2. Stretch suede, 3. Alcantara, 4. Luxury suede, 5. Artificial suede, 6. Felt, and 7. Velveteen

### Problems Resolved or Mitigated by the Present System

1. Loss of penis feeling and discomfort/pain

2. Visible incontinence

3. Erectile dysfunction

4. Excessively dry skin of the penis

5. Undesired penis contact to the scrotum

6. Excessive penis movement

7. Unwanted erections caused by fabric friction

8. Undesired scrotum contact to the legs

9. A means of securely holding a protective cup

### Detailed Description of the Present System

The present system is comprised of two components; an outer shell and a pouch structure integrated to the outer shell. The outer fabric shell can be represented by any garment designed to conform to a man's waist, hips and legs generally, as the shape is universal to any human torso, hips and legs.

### Background of Male Anti-Chafing Method

As described in previous applications, the preferred fabric material to be used in the construction of the male version of the pouch structure shall be “micro-suede”. It has been observed that this material exhibits significantly superior qualities in chafing reduction over any other fabric type. It is understood that this connection has not yet been observed and/or discussed. As an additional benefit, if the user is accustomed to being exposed to fabric/undergarments not utilizing micro-suede, then the user will experience in increase in sensation on or about said erogenous zones of the penis. Therefore, such a claim shall herein be made.

### Detailed Description of the Present System

The simplest description given to the present system is that of a genital or crotch hammock integrated into the front interior cavity of universally shaped underwear which conforms to the hips and legs generally. Said “hammock” is generally referred throughout the present application as the “pouch structure”. This performs many functions and contains many benefits described throughout. There are two versions of the present system, a male version and a female version.

### Description of the Male Version

For the male version, said pouch structure is preferably constructed in such a way as to form an isolated space or cavity for the male genitals, most especially the penis. It may be formed from one or more fabric panels, but is preferably constructed by integrating two separate fabric panels together, said panels forming a single pouch unit being preferably integrated by its upper and lower portions, by means of, but not limited by: knitting, sonic bonding, adhesive or a less permanent form of integration such as the use of Velcro, or buttons as a means of reversible integration.

The pouch structure is preferably integrated at any point along the bottom and top ends of the outer shell as indicated by the drawings. The pouch also having at least a majority portion of the side ends being left unattached enough so as to enable free side to side movement of the pouch structure as a means to mitigate the friction upon the genitals. The side ends being preferably wholly unattached from the outer shell as to enable maximum counter movement of the pouch against the outer shell.

The pouch structure may be comprised of any fabric type, but is preferably comprised of primarily stretch micro-suede, as it is significantly superior over any other fabric in restoring loss of feeling and reducing damaging friction to the erogenous zones of the penis.

The top access opening is preferably constructed by leaving the top end of the inner (gray) side of the pouch structure unattached from the outer (black) side of the pouch structure as indicated in the drawings. This is to enable the user easy use of the hands to allow convenient genital insertion and their adjustment within this space. If the isolation pouch is constructed from a single panel of fabric, then any opening shall suffice for this purpose.

The approximate dimensions of the isolation pouch must be large enough to reliably isolate the male genitals from contact with the outer shell fabric, legs, scrotum, and abdomen. The main purpose of the present system is to provide maximum protection to the penis, but if the scrotum is also desired as an option to insert, then the opening size of entry port may need to be increased to comfortably accommodate the scrotal portions of a man. This will, however, reduce the efficacy of penis entrapment within the pouch if separation of the penis from the scrotum is desired. The open space on the top end of the pouch structure must be large enough to fit the user's hand as to enable easy adjustment of the genitals.

Another benefit to the top opening is that it enables the user to flip down the waistband as a means to readily expose the penis for urination, adjustment, sexual activity or any other reason a user may have without requiring the user to first extract and reinsert through the genital entry port.

As a means for the user to insert the genitals into this formed cavity, a genital entry port on the user side face of the pouch structure is needed. Said entry port may be higher or lower for custom applications. The preferable form of genital entry port is that of a vertical slit as illustrated in FIGS. 3 and 4.

The genital entry port may be a slit, round or angular hole of any size or shape. Said port must be large enough to comfortably enable a user to insert the male genitalia and small enough to reliably prevent the penis of freely escaping from the confines of the pouch structure.

The pouch structure, especially in the male version, is generally triangular and takes the form of a trapezoid in the drawing in its preferred form. This is to allow easy access form the top for adjustment of the genital. This is not to limit the present design to such shape, as the isolation pouch may have a top end as narrow or less than the width of the pouch's bottom end. This is to increase the convenience of hand.

Said outer shell attachment points being at the approximate locations indicated relative to the outer shell and comprising dimensions sufficient to comfortably accommodate and secure the genitals, especially the penis in both up, side and down positions as a user may require.

### Bilateral Separation Barrier Structures

To further enhance the ability of the present system to guard the genitals from contact with the legs, support structures may be added as shown and described.

The best mode of this embodiment version is illustrated in FIG. 3. These generally triangular shaped bilateral structures act to mitigate scrotal sticking to the legs, to add stabilizing tension to the isolation pouch, and to provide overall improvement of genital entrapment over versions not utilizing them.

The bilateral barrier structures are preferably comprised of any form of fabric, but preferably comprised of mesh. They are spaced apart enough as to readily accommodate the scrotum and/or penis of the user.

The upper extent of the bilateral barrier structures is preferred to be at or near the genital entry port, when it is centered about the pouch structure as indicated in the drawings, said entry port however, they may be lower or higher.

The user side edge of said barrier structures are designed to conform to the groin crevices under slight tension when worn, thus acting as a barrier against genital contact from the legs. The bottom portions of the bilateral barrier structures are preferred to extend generally rearwardly to the bottom rear center of the outer shell as illustrated in FIGS. 3 and 4.

### Description of the Female Version

The female version of the present system like the male version, is best described as a “hammock” like structure integrated to the front inner face of hip and leg conforming underwear. Male and female genitalia are very different and so it would not be expected for them to utilize the same type of hammock structure to the same benefit. This is not to say, that one will hold benefit and not the other. Quite the contrary, as it has been discovered that by forming an absorbency pocket structure that is partially free from the outer shell allows the vagina more secure coverage whilst allowing the groin and thighs to be more comfort due to decreased restriction. Said pocket structure allows for the insertion of an absorbency pad into its cavity, although not necessary as the structure itself may be used as an absorbent barrier for vagina discharge.

Other designs having a pad or absorbency pocket fully integrated to the outer shell require the outer shell to be excessively snug and thus less comfortable for the user.

Additional benefits to the present system for female use, allow for better cooling for the genitals, increasing overall health and comfort for the user. Another benefit is by having a partially free fabric against the vagina helps prevent undesired soiling of the outer shell. The pocket pouch structure also need not any absorbency pad placed within its cavity to perform the function of discharge protection, as the material itself can do well to perform this on its own.

As an example, the side of the user may be comprised of an absorbent material whilst the outer side (facing away form the user) may be comprised of an impermeable material preventing the soiling of the outer shell from excess vaginal discharge. The pouch structure for the female version is preferred to have a port upon the face of the pouch structure which faces the user in which an absorbency pad (if used) may more efficiently absorb vaginal discharge, saving the pouch structure from excessive uptake of said discharge. Said vaginal discharge port being placed upon the user side of the pouch structure, naturally.

### BEST MODE

The best mode for the male version of the present system is illustrated in FIG. 3, which comprises a slit form of genital entry port and genital barrier structures integrated along only approximately half of the length of the side of the genital isolation pouch structure. The top of end of said preferred embodiment extending only to the center of the edge length. This allowed for better movement, whilst providing adequate tension of the isolation pouch against the user preventing both the escape of the penis from the isolation pouch and contact of the scrotum to the legs.

The best mode for the female version is illustrated in FIG. 5, being comprised of a discharge port as indicated.

### BRIEF DESCRIPTION OF THE DRAWINGS

The embodiments in the drawings are shown from a top-down forward facing view of the interior front face of a “boxer brief” style outer shell designed to conform generally to the user's waist, hips and thighs. The drawings also illustrate the difference between the versions of the present system.

The white sections within the black lines represent the outer fabric shell structure. The gray section, where applicable, represents the inner user side of the isolation pouch and to illustrate that there is an interior space or cavity within the pouch structure. The checkered pattern represents the bottom portion of the outer shell to which the bilateral barrier structures are integrated.

FIG. 1

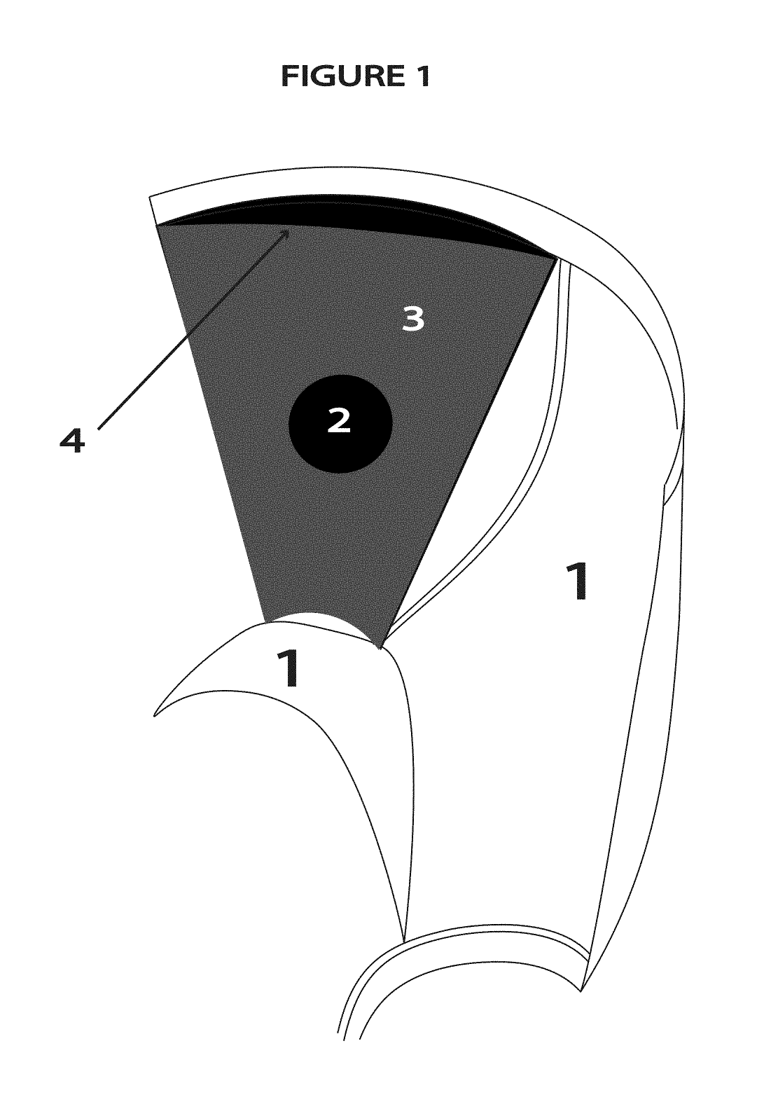

An embodiment within the scope of claim 2. Note the form of genital entry port being a round hole. This embodiment also has a partially removed bottom end. The bottom end will always be attached along at least some of its length, but not necessary along its whole length

1. Outer Shell

2. Genital Entry Port (slit)

3. Isolation Pouch Structure

4. Top opening for hand access

FIG. 2

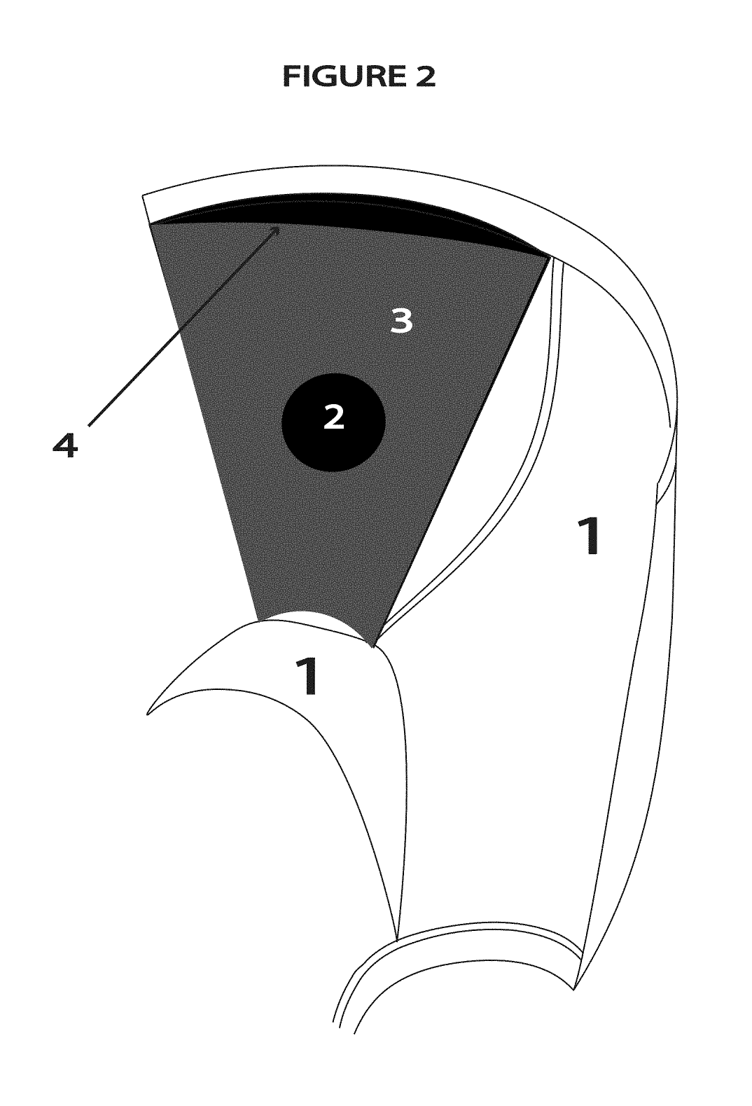

An embodiment within the scope of claim 2. Note the form of genital entry port being a slit.

1. Outer Shell

2. Genital Entry Port (round hole)

3. Pouch structure

4. Top opening of pouch structure

FIG. 3

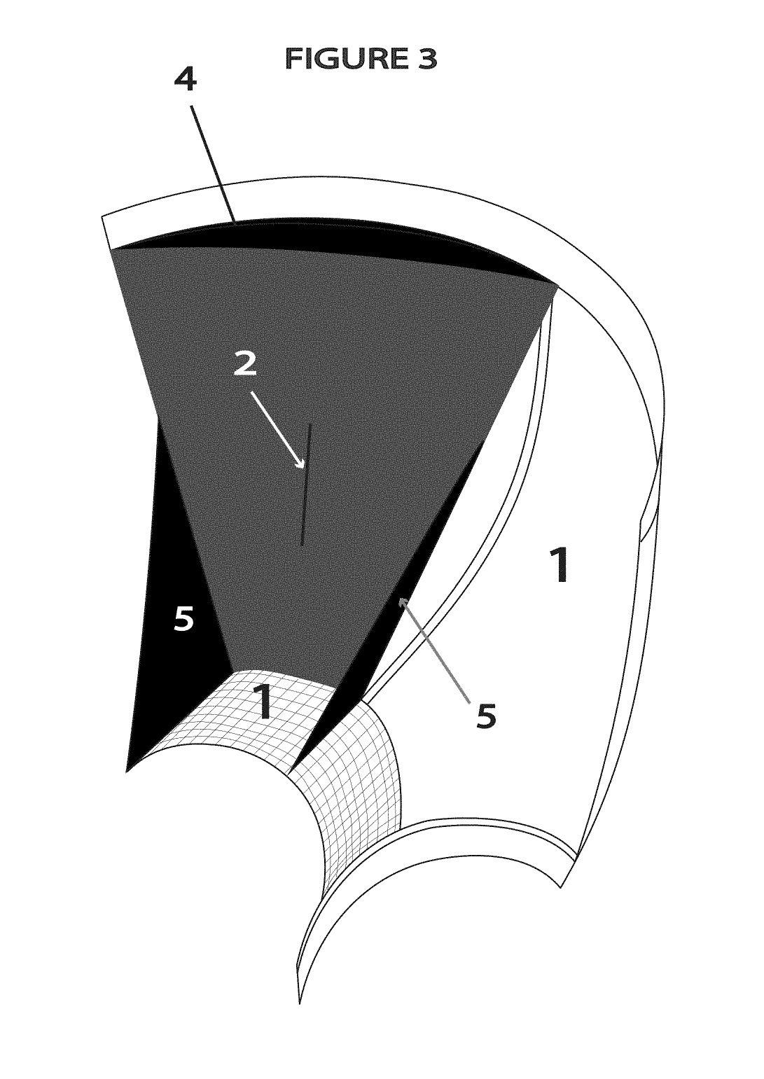

The preferred embodiment and best mode and an embodiment within the scope of claim 3. Note the triangular shaped panels at each side of the isolation pouch structure. These structures help mitigate the scrotum from contacting the legs.

1. Outer Shell

2. Genital Entry Port (round hole)

3. Pouch Structure

4. Top opening of pouch structure

5. Genital Barrier Structures

FIG. 4

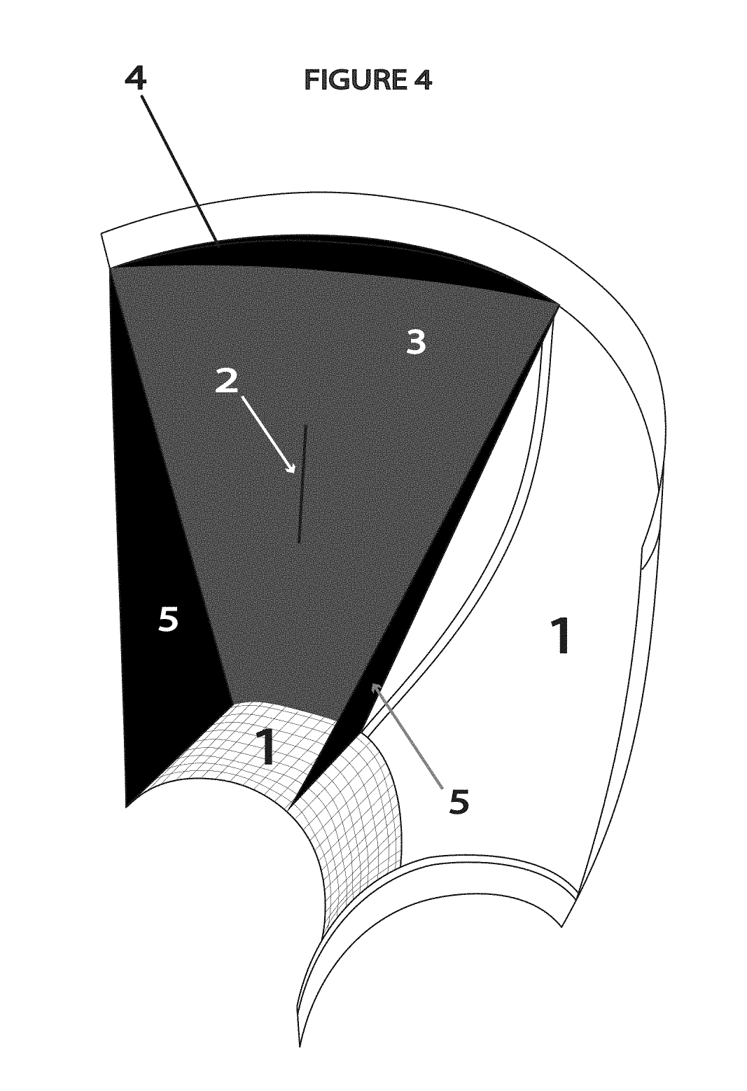

An embodiment within the scope of claim 3. Note how the genital barrier structures may extend to the upper portion of the pouch structure if the user requires increased reliability of genital entrapment. This will, however, limit the freedom of movement of the penis in contrast to the embodiment in FIG. 3.

1. Outer shell

2. Genital entry port (slit)

3. Pouch structure

4. Top opening of pouch structure

5. Genital barrier structures

FIG. 5

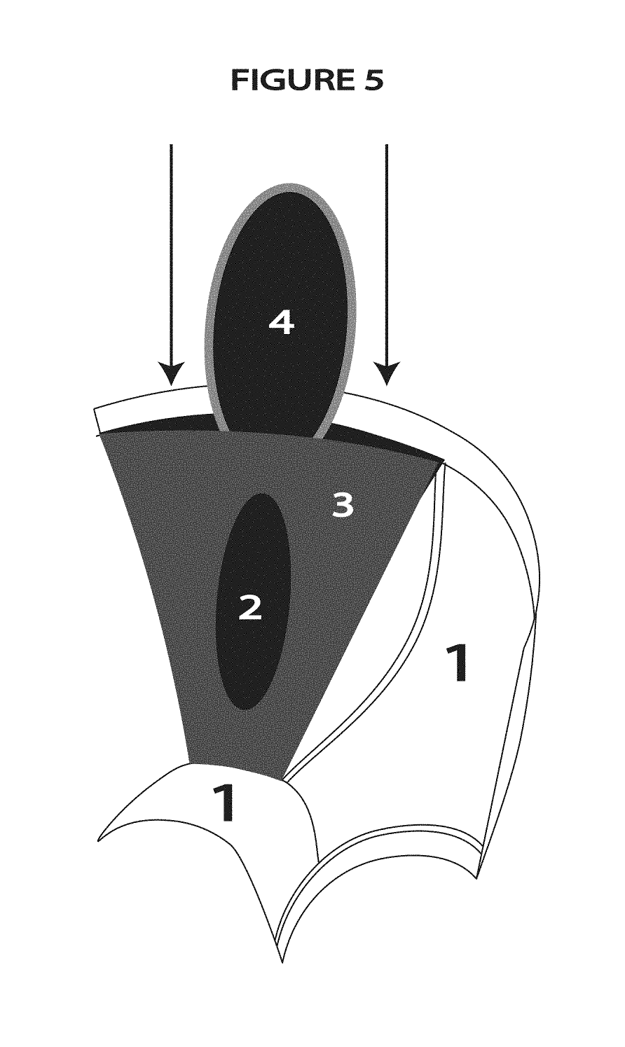

An embodiment within the scope of claim 5, and the best mode for the female version of the present system. Note how an absorbency pad is placed into the cavity of the pouch structure as indicated.

1. Outer shell

2. Discharge exposure port

3. Pouch Structure

4. Absorbency pad

I claim:

1. A method for reducing the chafing discomfort of male genitalia in undergarments, said method comprising the application of micro-suede to the interior portions of male undergarments in such a way as to prevent the penis from contacting other parts of the body and/or other fabric types.

2. A male underwear system comprising a hip and leg conforming shell, said shell further comprising:
A genital isolation pouch structure, said structure being integrated to the interior front face of said shell; and
said pouch structure further comprising an open top end, a closed bottom end and two closed side ends, thereby forming an interior spacial compartment/cavity for the male genitalia; and
said top and bottom ends being integrated to the interior front face of said shell; and
the side ends of said pouch being unattached from the interior front face of the outer shell as to enable partial free movement of said pouch against the outer shell; and
said pouch structure further comprising an entry port for insertion of the male genitalia into the cavity of said pouch structure.

3. The underwear system of claim 2, said system further comprising bilateral genital barrier structures; and
said structures being integrated along the length of the outside edges of said pouch structure and said barrier structures being further integrated to the bottom interior portion of said outer shell of claim 2.

4. A female underwear system comprising a hip and leg conforming shell, said shell further comprising:
A pad holding pouch structure, said structure being integrated to the interior front face of said shell; and
said structure being integrated to the interior front face of said shell by only its top and bottom ends, and
said pouch further comprising an open top end, a closed bottom end and two closed side ends, so as to form an interior cavity thereby; and

5. The underwear system of claim 4, said pouch structure further comprised of a vaginal discharge port upon the side facing the user.
